(19) United States
(12) Patent Application Publication
(10) Pub. No.: US 2010/0162256 A1
(43) Pub. Date: Jun. 24, 2010

(54) OPTIMIZATION OF APPLICATION POWER CONSUMPTION AND PERFORMANCE IN AN INTEGRATED SYSTEM ON A CHIP

(76) Inventors: Alexander Branover, Chestnut Hill, MA (US); Helmut W. Prengel, Burkau (DE); Anthony Asaro, Toronto (CA); Sebastian Nussbaum, Lexington, MA (US); Maurice B. Steinman, Marlborough, MA (US)

Correspondence Address: MEYERTONS, HOOD, KIVLIN, KOWERT & GOETZEL (AMD), P.O. BOX 398, AUSTIN, TX, 78767-0398, US

(21) Appl. No.: 12/338,459

(22) Filed: Dec. 18, 2008

(51) Int. Cl. G06F 9/46

(52) U.S. Cl. 718/104

(57) ABSTRACT

A method for determining an operating point of a shared resource. The method includes receiving indications of access demand to a shared resource from each of a plurality of functional units and determining a maximum access demand from among the plurality of functional units based on their respective indications. The method further includes determining a required operating point of the shared resource based on the maximum access demand, wherein the shared resource is shared by each of the plurality of functional units, comparing the required operating point to a present operating point of the shared resource, and changing to the required operating point from the present operating point if the required and present operating points are different.

### BACKGROUND OF THE INVENTION

1. Field of the Invention

This invention relates to integrated circuits, and more particularly, to the optimization of performance and power consumption for a system on a chip.

2. Description of the Related Art

Power consumption and performance are two factors that must be considered in designing computers and other types of processor-based electronic systems. Generally speaking, higher performance results in a higher amount of power consumed. Conversely, limiting the amount of power consumed limits the potential performance of a computer or other type of processor-based electronic system. In addition, secondary (but related) factors such as thermal output (which is related to power consumption) must also be considered. Thus, achieving the maximum performance per unit of power consumed (power/watt) is a key metric in the design of processor-based systems. This is particularly true in portable, battery powered systems, where minimizing power consumption is critical.

System bottlenecks are one area in which disproportionately impact system performance, and thus provide opportunities to a system designer for performance optimization. This is particularly true of shared resources, such as buses or shared memory used by a number of different agents (e.g., processors or processor cores, I/O devices, graphics devices).

One method of dealing with the tradeoffs between power and performance for a shared resource is to optimize the power consumption characteristics of the resource. More particularly, the resource may be designed to consume less power at its highest performance point. Another method is to throttle accesses to the shared resource, which reduces the number of operations performed by the shared resource.

### SUMMARY OF THE INVENTION

A method for determining an operating point of a shared resource is disclosed. In one embodiment, the method includes receiving indications of access demand to a shared resource from each of a plurality of functional units and determining a maximum access demand from among the plurality of functional units based on their respective indications. The method further includes determining a required operating point of the shared resource based on the maximum access demand, wherein the shared resource is shared by each of the plurality of functional units, comparing the required operating point to a present operating point of the shared resource, and changing to the required operating point from the present operating point if the required and present operating points are different.

In one embodiment, the method includes receiving indications from each of the functional units aperiodically. The indications may be indications of a performance state of the functional unit, or may be access requests to the shared resource. In embodiments wherein the indications are indications of performance state, a highest performance state may be determined from among the plurality of functional units, and the operating point of the shared resource may be determined based on the determined highest performance state. In embodiments where the indications are access requests, a counter may be used to track the access requests. The counter value may be compared to one or more threshold values to determine the operating point of the shared resource. The counter may be incremented each time an access request is received, and may be decremented for each period of predetermined time interval that elapses without receiving a subsequent access request.

A computer system is also disclosed. In one embodiment, the computer system includes at least one shared resource and a processor. The processor includes a plurality of functional units and a controller, wherein the controller is coupled to receive indications of access demands to the at least one shared resource from each of the plurality of functional units. The controller is configured to determine a maximum access demand from among the plurality of functional units based on their respective indications, determine a required operating point of the at least one shared resource based on the maximum access demand, compare the required operating point to a present operating point of the at least one shared resource, and change to the required operating point from the present operating point if the required and present operating points are different.

### BRIEF DESCRIPTION OF THE DRAWINGS

Other aspects of the invention will become apparent upon reading the following detailed description and upon reference to the accompanying drawings in which:

FIG. 1 is a block diagram of one embodiment of a system having a plurality of functional units configured to access a shared resource;

FIG. 2 is a block diagram of a processor according to one embodiment;

FIG. 3 is a flow diagram of one embodiment of a method for determining an operating point of a shared resource;

FIG. 4 is a flow diagram of one embodiment of a method for determining the operating point that meets the access demand for a functional unit;

FIG. 5 is a block diagram illustrating one embodiment of a controller used for determining an operating point of a shared resource;

FIG. 6 is a block diagram illustrating another embodiment of a controller used for determining an operating point of a shared resource;

FIG. 7 is a flow diagram of another embodiment of a method for determining an operating point of a shared resource;

FIG. 8 is a flow diagram illustrating a method the setting of a counter value for determining the operating point of a shared resource in accordance with claim 7;

FIG. 9 is a block diagram of one embodiment of a controller configured to perform the control functions in accordance with the method of FIGS. 7 and 8;

FIG. 10 is a flow diagram illustrating one embodiment of a method for changing operating points; and

FIG. 11 is a flow diagram illustrating one embodiment of a method for changing operating points for a shared dynamic random access memory.

While the invention is susceptible to various modifications and alternative forms, specific embodiments thereof are shown by way of example in the drawings and will herein be described in detail. It should be understood, however, that the drawings and description thereto are not intended to limit the invention to the particular form disclosed, but, on the contrary, the invention is to cover all modifications, equivalents, and alternatives falling within the spirit and scope of the present invention as defined by the appended claims.

### DETAILED DESCRIPTION OF THE INVENTION

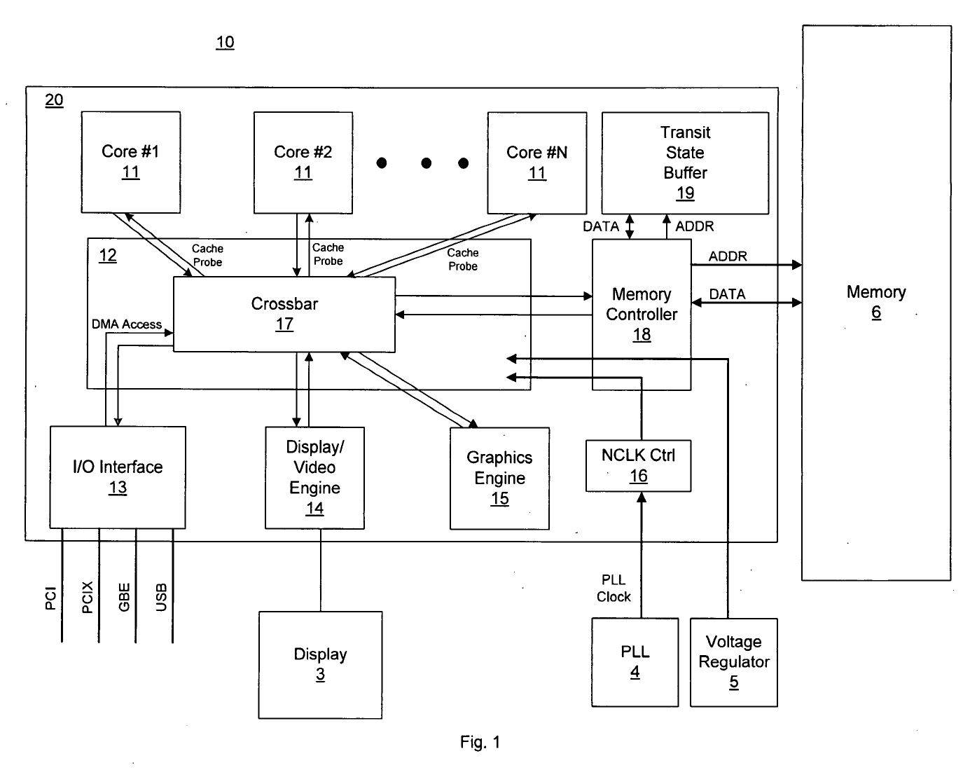

Turning now to FIG. 1, a block diagram of one embodiment of a system having a plurality of functional units configured to access a shared resource is shown. In the embodiment shown, computer system 10 includes processor 20, which may be referred to as a system on a chip. Processor 29 includes a north bridge 12, which in turn includes crossbar switch 17. Crossbar switch 17 is configured to provide switching functions that direct and route traffic between the various functional units coupled thereto. The various functional units coupled to crossbar switch 17 include a plurality of processor cores 11, an I/O interface 13 (i.e. a south bridge), a display/video engine 14, a graphics engine 15, and memory controller 18. It should be noted that additional connections between the various functional units that are not explicitly shown here may also be present. Such connections may include data buses, address buses, control buses, and any other necessary connection.

As previously noted, processor 20 as shown herein includes a plurality of processor cores 11. Embodiments having only a single processor core are also possible and contemplated. In one embodiment, processor 20 may be a symmetrical multi-core processor, meaning that processor cores 11 are identical to each other. Embodiments of processor 20 that are asymmetric (or heterogeneous) multi-core are also possible and contemplated. Each processor core 11 may perform typical functions associated with processor cores, such as fetching and executing instructions and storing the results thereof. Each processor core 11 may include one or more execution units, which may in turn include integer units, floating point units, and fixed point units. Processor cores 11 may also each include at least one cache memory, and may, through crossbar switch 17, perform cache probes of the other processor cores in order to ensure cache coherency.

I/O interface 13 in the embodiment shown is a south bridge device that is configured to provide interfaces between processor 20 and other I/O devices such as printers, keyboards, mice, and so forth (not explicitly shown here). Devices may be coupled to processor 20 through I/O interface 13 via buses such as a PCI (Peripheral Component Interconnect) bus, a PCIE (PCI-Extended), and Universal Serial Bus (USB), as well as through a Gigabit Ethernet (GBE) connection. Other types of buses not explicitly shown here may also be coupled to processor 20 through I/O interface 13.

Computer system 10 includes a display 3, which is coupled to processor 20 through display/video engine 14. Display 3 may be any type of display, such as a flat panel plasma or LCD (liquid crystal display), or a CRT (cathode ray tube). Display/video engine is configured to perform various video processing functions and provide information to display 3 that is then converted into a visual format for display. Display/video engine 14 may include video memory. Some video processing functions that cannot be handled by display/video engine 14 may instead be handled by graphics engine 15. Functions such as 3-D processing and other types of graphics processing for gaming, video playback, and so forth, may be handled by graphics engine 15.

Computer system 10 includes a memory 6 that is coupled to processor 20 via memory controller 18. Memory 6 in one embodiment is a form of random access memory (RAM), and may be double data rate (DDR) RAM. Memory controller is configured to provide address information via an address bus (ADDR) for accessing memory 6 for reads and writes. Data may be transferred between memory controller 18 and memory 6 on a bid-directional data bus (DATA). Memory controller 18 is configured to coordinate memory accesses to memory 6 by the various functional units coupled to north bridge 12.

In the embodiment shown, north bridge 12, memory controller 18, and memory 6 are all resources that are shared by the other functional units. Accordingly, these resources may have a significant impact on system performance. Furthermore, these shared resources may have a significant impact on the overall power consumption by processor 20, and thus computer system 10. Thus, as will be discussed below, processor 20 includes functionality directed to balancing power consumption and system performance in an effort to provide the maximum amount of performance per watt of power consumes.

Power consumption by the shared resources is dependent on both a clock frequency and a voltage at which they operate. Processor 20 is configured to receive power via voltage regulator 5 (which receives power from an external source not shown here), and a clock signal from PLL (phase locked loop) 4. The clock signal is provided to both memory controller 18 and north bridge 12 via clock control unit 16. The shared resources may be controlled by operating them at different operating points. In the embodiment shown, each operating point includes a voltage and at least one clock frequency, both of which may be adjusted. Accordingly, if the shared resources shown herein are configured to operate at four different operating points, they can thus operate at four different voltage/clock frequency combinations. In an embodiment to be discussed below, a control header (to be discussed below) is configured to output the voltage and two clock frequencies, one at which the north bridge operates, and one at which the memory operates.

When changing operating points, the clock signals and the voltages may be interrupted. Accordingly, data transfer between memory 6 and memory controller 18 may be interrupted during the change of operating point. However, some data may be latency sensitive (such as data being provided to display/video engine 14). Accordingly, processor 20 includes transit state buffer 19, which can be used to store and provide data during changes of the operating point from one to another. Although transit state buffer 19 is not explicitly shown as being coupled to functional units other than memory controller 18, it is assumed that it is coupled at least to display/video engine 14, and may be further coupled to any of the other functional units shown, including the processor cores 11, graphics engine 15, and I/O interface 13. Transit state buffer may be written to by or read from any functional unit to which it is coupled. Accordingly, other operations of processor 20 can continue largely uninterrupted even though access to memory 6 may be temporarily unavailable. Access to transit state buffer 19 may be initiated by a handshake operation when it is determined that a change of operating points is to occur. The handshake operation may include a controller sending a notification of the impending operating point change to all affected functional units, and the controller receiving acknowledgement from all of the affected functional units.

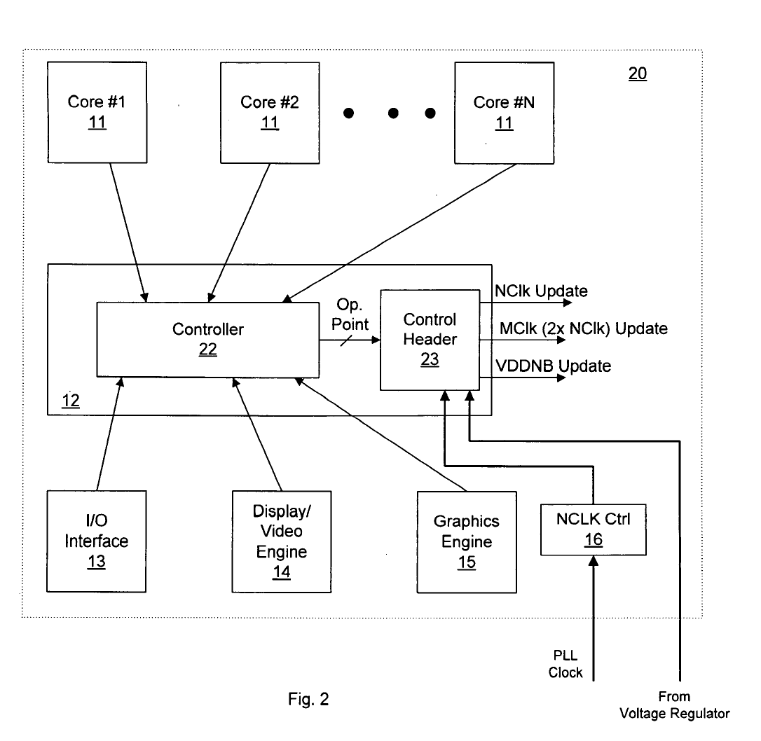

Turning now to FIG. 2, a block diagram of a processor according to one embodiment is shown. Processor 20 as shown in FIG. 2 includes various ones of the same (or similar) functional units as that shown in FIG. 1. These functional units include processor cores 11, I/O interface 13, display video engine 14, and graphics engine 15. Processor 20 may also include other functional units that were shown in FIG. 1 that are not explicitly shown here.

In the embodiment shown, north bridge 12 includes a controller 22 and a control header 23. Controller 22 is coupled to receive indications of a demand for access from each of processor cores 11, I/O interface 13, display/video engine 14, and graphics engine 15. Embodiments of processor 20 including other functional units coupled to controller 22 and configured to provide indications of access demand are also possible and contemplated. The indications of access demand from a given functional unit may indicate demand for access to any one of or all of the shared resources of computer system 10, namely north bridge 12, memory controller 18, and memory 6. The indications may occur in various forms, such as access requests to one or more of the shared resources, processing loads, anticipated access demand based on workload, and so forth. In some embodiments, the indications may be received aperiodically (i.e. randomly) from the various functional units, e.g., whenever the workload for a given functional unit changes. In another embodiment, each functional unit may provide an access demand indication to controller 22 on a periodic basis. In still another embodiment, controller 22 may be configured to poll each of the functional units for their respective access demands. The polling may be performed periodically or aperiodically.

Controller 22 is configured to determine an operating point for the shared resources based on the received indications. More particularly, controller 22 may determine the maximum access demand to the shared resources (and thus a maximum required performance) and may thereby determine the proper operating point of the shared resources in accordance therewith. Various methods of accomplishing this task will be discussed in further detail below. The task of determining the operating point may be performed for each of a plurality of successive intervals, in a periodic manner. In one embodiment, controller 22 may determine the operating point every 1 milliseconds. However, the specific interval may be greater or less than this particular example, in accordance with the requirements of the specific implementation. The required operating point information is provided to control header 23 in this example, and may be provided as often as the update interval at which it is determined.

Various combinations of hardware, software, or firmware may be used to implement controller 22. Furthermore, controller 22 may include storage (e.g., registers or other type of memory) to store thresholds, voltage and frequency parameters for various operating points, and so forth. It is also noted that while controller 22 is shown herein as a component of north bridge 12, embodiments are possible and contemplated wherein controller 22 is not a component of north bridge 12. In other embodiments, controller 22 may be implemented as software instructions that are executed by a designated one of processor cores 11, or may be implemented as a separate, stand-alone unit, to give a few of many possible examples.

As noted above, control header 23 is coupled to receive operating point information from controller 22. Control header 23 is also coupled to receive a clock signal from clock control unit 16 and voltage regulator 5. Responsive to the operating point information provided from controller 22, control header 23 is configured to perform control actions that set the frequency of the north bridge clock (Nclk) signal, the memory clock signal (which is 2× the north bridge clock in this embodiment), and the north bridge operating voltage (VDDNB). In this embodiment, control header 23 is coupled to provide a control signal to clock control unit 16 in order to set the frequency output therefrom. The north bridge clock signal is distributed to other circuitry in north bridge 12, while the memory clock signal is provided to memory controller 18 and memory 6 of computer system 10. As such, control header 23 may include circuitry such as an additional PLL or other types of clock multiplier/divider circuitry as necessary. Control header 23 may also include level shifter circuitry for the purposes of changing the voltage VDDNB in accordance with the changing of the operating point. As with the north bridge clock, the north bridge operating voltage VDDNB is also provided as the operating voltage to at least north bridge 12 and memory controller 18, and may also be provided as the operating voltage to memory 6. Accordingly, in the embodiment shown, control header 23 receives information regarding the operating point from controller 22 and sets the operating point by setting the voltages and clock frequencies output therefrom.

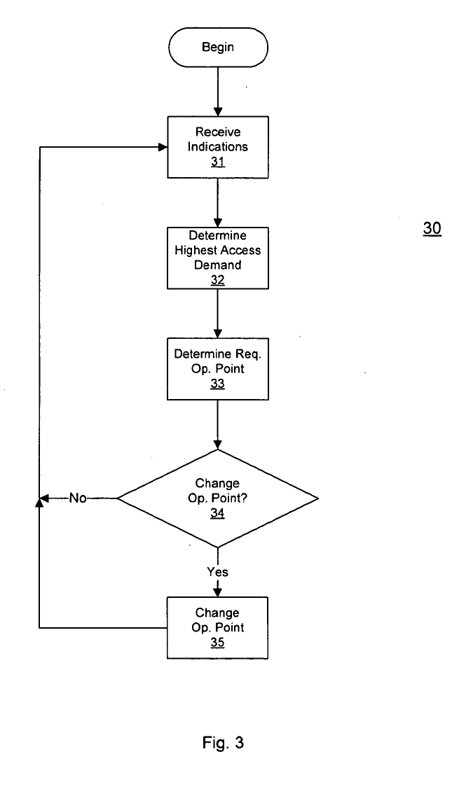

FIG. 3 is a flow diagram of one embodiment of a method for determining an operating point of a shared resource. Method 30 is one embodiment of a method that may be performed by controller 22 and control header 23 in determining and setting an operating point. In the embodiment shown, method 30 begins with the receiving of indications of access or access demand from a plurality of functional units that utilize one or more shared resources (31). As discussed above, the functional units may be processor cores, I/O interfaces and so forth, while the shared resources may include one or more of a north bridge, a memory controller, or a memory. Other types of shared resources are also possible and contemplated. The indications may be requests for access to one or more of the shared resources, indications of workload, anticipated access demand, and so forth. In general, the indications provide information regarding the required performance level of the shared resource(s) based on the amount of required access thereto. The indications may be received periodically or aperiodically (e.g., randomly), and further, may be received responsive to a request from a controller.

Based on the received requests, a highest access demand is determined (32). In one embodiment, the highest access demand may be that as indicated by a particular one of the plurality of functional units. In another embodiment, the highest access demand may be a composite or aggregate value based on the indications provided by the plurality of functional units. Based on the highest access demand, the required operating point is determined (33). The operating point may include a combination that includes at least one operating voltage and at least one clock frequency. In the embodiment of FIGS. 1 and 2, the operating point includes one operating voltage (VDDNB) and two clock frequencies (NClk and MClk, which is 2× NClk in this case). Embodiments wherein an operating point includes two or more operating voltages and two or more independently adjusted clock frequencies are possible and contemplated.

After the required operating point has been determined, a comparison is made to determine whether the operating point needs to be changed (34). If the required operating point is the same as the current operating points, then no change occurs (34, no). If the required operating point is different than the present operating point (34, yes), then the operating point is changed (35). Changing to a higher performance operating point may include raising the operating voltage (or at least one operating voltage in multi-voltage environments), and/or increasing at least one clock frequency. In the embodiment of FIGS. 1 and 2, changing to a higher performance operating point may include raising VDDNB and/or raising the frequency of NClk (whereas the frequency of Mclk is increased as a consequence of increasing NClk). Conversely, changing to a lower power operating point includes reducing at least one operating voltage and/or reducing at least one clock frequency.

Generally speaking, higher performance operating points consume more power, while low power operating points provide less performance. As few as two operating points may be used in some embodiments, while other embodiments may utilize a least one low power operating point, a high performance operating point, and one or more intermediate points (where the performance and power consumption falls between the high and low points).

In some cases, it may be necessary to weigh the access demands indicated by the various functional units that require access to the shared resource. For example, an I/O engine such as that discussed above, may at its highest access demand, require less access than a processor core at its highest demand (or even at demand level that is not at its peak). Thus, in one embodiment, the access demand for each functional unit is given a score, and these scores may be scaled to provide a scaled score when determining the operating point. Table 1 below provides an example of scaling and scoring for a processor core.

TABLE 1

| P-state # | Core Frequency | | Score | Scale Factor | Scaled Score |
|---|---|---|---|---|---|
| P0 | 2 | GHz | 4 | X2 | 8 |
| P1 | 1.5 | GHz | 3 | X2 | 6 |
| P2 | 1 | GHz | 2 | X2 | 4 |
| P3 | 0.5 | GHz | 1 | X1 | 1 |

| | | | | |
|---|---|---|---|---|
| Idle | Idle | 1 | X1 | 1 |

In the example above, a processor core includes 4 operational states (referred to here as P-states) and an idle state. The operating states of the processor core may correspond to operation at a particular operating voltage and clock frequency, although these parameters may be different than those of the shared resources. Changes between these states may include changing at least one of the clock frequency or operating voltage. In the example of Table 1, changes between states are limited to a change of clock frequency, although embodiments where voltage changes (either with clock frequency or as an alternative thereto) from one state to another are contemplated. The operating states may be indicative of both a workload and demand for access to the shared resources (or anticipated demand). P-state 0 (P0) is the highest performance state of the exemplary processor core, with an operating frequency of 2.0 GHz, while P-state 3 (P3) is the lowest performance non-idle state. Since P-states 0, 1, and 2 are likely to require high accessibility to the memory controller, the memory, and the north bridge, and manifest high dependency of the processor performance on memory latency and bandwidth, the scores for these P-states are scaled at ×2 (times two), while P-state 3 and the idle state are scaled at unity. Thus, since P-state 0 has a score of 4 and a scale factor of ×2, its scaled score is 8. P-state 1 has a score of 3 and a scale factor of ×2, and thus its scaled score is 6. The computing of the scaled scores for the other operating states is performed in a similar manner.

As with the exemplary processor core discussed above, each of the other functional units may also have a number of operating states, each of which has a respective score, and may also have a scale factor. In performing the method of FIG. 3, each of the functional units may provide an indication of its current operating state to the controller. The controller may assign a score to each functional unit based on its indicated operating state, and may further scale the scores as discussed above. In one embodiment, the controller may then determine the required operating state based on the highest score (or scaled score) among the functional units. After determining the score for each functional unit, an algorithm may be performed for each functional unit to determine the operating point that meets that functional unit's access demand. The algorithm below provides one such example:

If (score>=threshold 0), then access demand=Max

else if (score>=threshold 1), then access demand=Mid1

else if (score>=threshold 2), then access demand=Mid2

else access demand=Low.

In the example above, four different operating points for the shared resource(s) are provided, Max, Mid1, Mid2, and Low. The MAX operating point is at the highest voltage value for VDDNB and highest clock frequency, while the Low operating point is at the lowest of these same parameters. The Mid1 and Mid2 operating points are intermediate operating points between the Max and Low points.

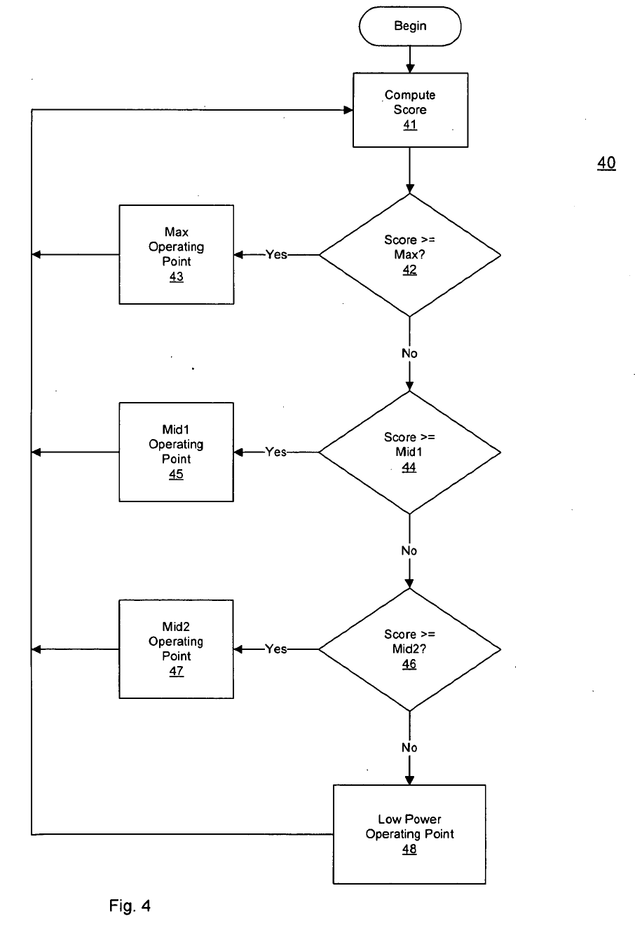

A form of the algorithm discussed above is further illustrated in FIG. 4. The algorithm may be performed by controller 22 for each of the functional units in order to determine the operating point that meets their respective access demands. Method 40 begins with the computation of a score for a particular functional based on the indications provided therefrom (41). The score may be scaled or non-scaled, depending on the particular implementation. After the score is determined it is compared to the Max threshold (42). If the score meets or exceeds the Max threshold (42, yes), then the Max operating point is determined to be the required operating point (43) of the shared resource that meets the access demand of the particular functional unit. If the score is less then the Max threshold (42, no), then the scored is compared to the Mid1 threshold (44). If the score meets or exceeds the Mid1 threshold (44, yes), then the Mid1 operating point is determined to be the operating point (45) that meets the access demand of the functional unit. If the score is less than the Mid1 threshold (44, no), then the score is compared to the Mid2 threshold (46). If the score is greater than or equal to the Mid2 threshold (46, yes), then the Mid2 operating point is determined to be the operating point (47) that meets the access demand for the functional unit. If the score is less than the Mid2 threshold (46, no), then it is determined that the Low operating point meets the access demand of the functional unit.

After the above algorithm is performed for each of the functional units, the controller may select the maximum performance operating state that resulted from the comparisons. Table 2 below provides an example of one such set of comparisons.

TABLE 2

| | Required Operating Point to Meet Access |
|---|---|
| Functional Units | Demand |
| Core 0 | Mid2 |
| Core 1 | Mid2 |
| Video/Display | Mid1 |
| Graphic | Low |
| I/O | Low |

Table 2 is illustrative of an example for a processor that includes two cores, as well as the video/display engine, the I/O interface, and the graphics engine as discussed above. For a given interval, the algorithm as discussed above has been performed for each of the functional units. Based on the results, it is determined that both core 0 and core 1 require the Mid2 operating point to meet their respective access demands, the video requires the Mid1 operating point to meet its access demand, while the graphics engine and I/O interface require only the low operating point to meet their respective access demands. Since Mid1 is the highest operating point that resulted from the comparison operations (corresponding to the access demand of the video/display unit), it is selected as the operating point. After determining the operating point, controller 22 forwards this information to control header 23, which compares this information to the current operating point and changes it, if necessary.

As an alternative to performing the algorithm of FIG. 4 for each functional unit, controller 22 may select the functional unit having the highest computed score. The comparison algorithm can then be performed a single time based on the highest computed score. For example, if the score computed based on the indication of P-state provided by processor core 0 is the highest score computed from among the plurality of functional units, it is chosen as the basis for performing a single pass of the algorithm of FIG. 4, and the required operating point is determined based on this result. This may allow a faster and more efficient means of determining the required operating point to meet the maximum access demand from among the functional units. Other embodiments wherein scores from among the functional units are combined, averaged, or determined in ways that are different than that discussed above are also possible and contemplated, with these scores being used as a basis for the comparison algorithm.

It should be noted that the number of operating points discussed in the above embodiments is exemplary. Embodiments utilizing a greater or lesser number of operating points are possible and contemplated. As few as two operating points may be used in some embodiments, while there is no theoretical upper limit to the number of operating points that may be implemented for any given embodiments.

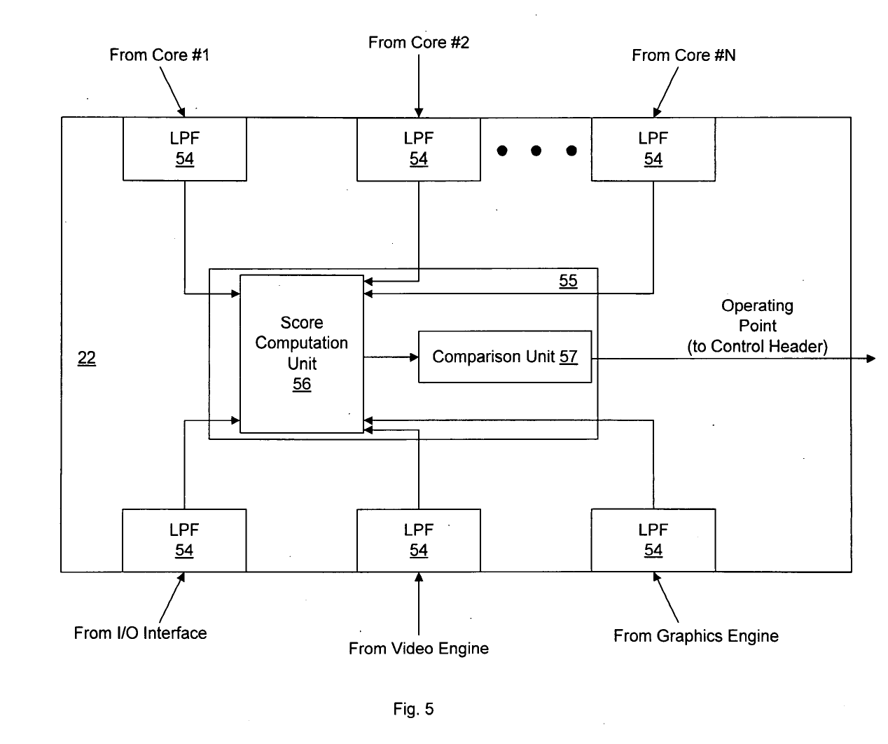

FIG. 5 is a block diagram illustrating one embodiment of a controller used for determining an operating point of a shared resource. In the embodiment shown, controller 22 includes a state determination unit 55 and a plurality of low pass filters 54. This embodiment of controller 22 is suitable for use in embodiments wherein the functional units provide aperiodic indications of access demand. Each of the low pass filters 54 is coupled to a unique one of the functional units with respect to the other ones of the functional units. Each time the access demand for a respective functional unit changes, it provides an indication to controller 22 via its respective low pass filter 54. Each low pass filter 54 is configured to ignore (effectively ‘filtering out’) excessive changes in access demand by its respective functional unit.

State determination unit 55 is configured to determine the required operating point based on the respective access demands reported by the functional units. In the embodiment shown, state determination unit 55 includes a score computation unit 56 and a comparison unit 57. Score computation unit 56 is configured to compute the scores for each of the functional units based on the indications of access demand. Scores for each functional unit may be computed at various intervals, e.g., every 1 millisecond. In accordance with the examples given above, scores for various ones of the functional units may be scaled based on their respective P-states, relative priority for access, and/or other factors. The scores may then be forwarded to comparison unit 57, which may perform the algorithms discussed above with reference to FIGS. 3 and 4. In one embodiment, comparison unit 57 may perform the comparison algorithm of FIG. 4 for each of the computed scores, and then select the highest performance operation point resulting from the comparisons. In another embodiment, comparison unit 57 may compare the scores to each other, select the highest score, and then perform the algorithm of FIG. 4 to determine the required operating point.

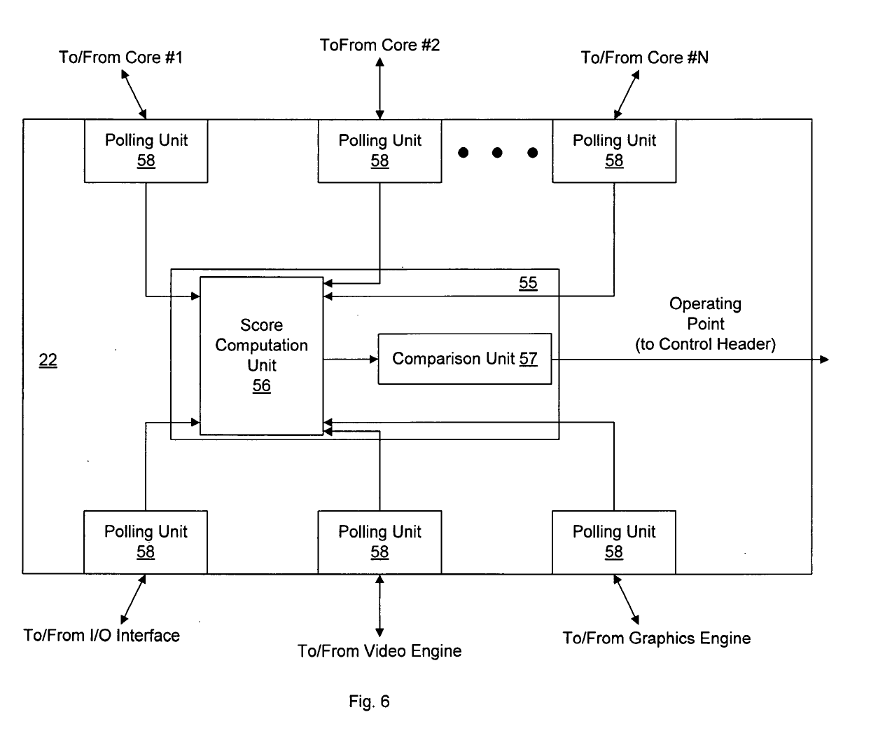

FIG. 6 is a block diagram illustrating another embodiment of a controller used for determining an operating point of a shared resource. Controller 22 in this particular embodiment includes a state determination unit 55 that is largely similar to that of the embodiment discussed above with reference to FIG. 5. More particularly, state determination unit 55 in this embodiment includes a score computation unit 56 and a comparison unit 57 that may perform functions that are identical to their counterparts shown in FIG. 5. However, this particular embodiment of controller 22 includes a plurality of polling units 58 instead of the low pass filters 54 of the embodiment of FIG. 5. Each of the polling units 58 is configured to periodically poll a respectively coupled functional unit. In response, each functional unit is configured to respond by indicating its access demand to its respective polling unit. Each polling unit 58 is then configured to forward the indication of access demand to state determination unit 55, where scores can be computed and comparisons made to determine the required operating point.

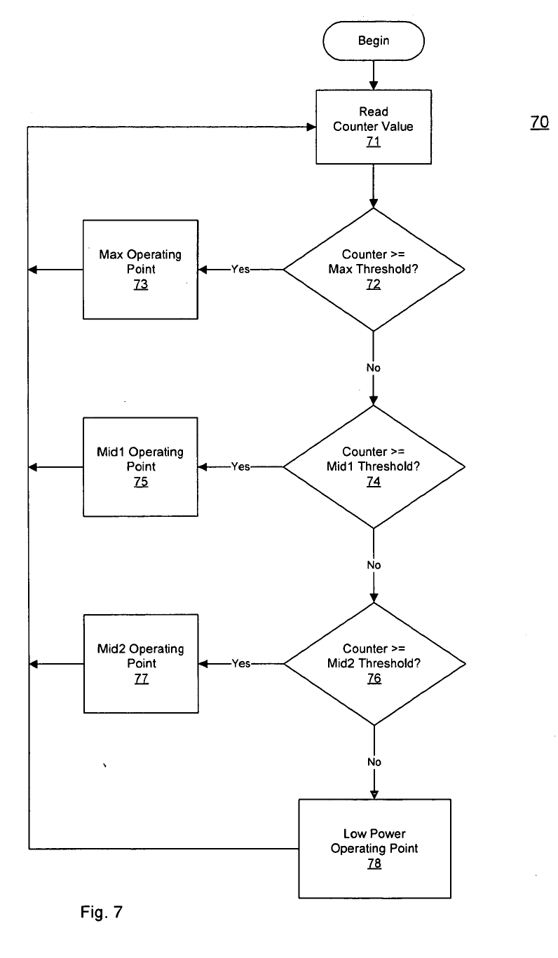

Another embodiment for determining the required operating point may be performed using a counter. In this embodiment, the counter is incremented each time a functional unit submits a request for access to one of the shared resources. The counter is decremented for each time interval that elapses, regardless of how many access requests have been received during the interval. Thus, for each given time interval, the counter will decrement once and will increment according to the number of access requests received therein (which may be as low as zero, and has no theoretical upper limit. The counter value therefore increments and decrements according to the level of access requests for the plurality of functional units. The counter value may be periodically compared to one or threshold values to determine the operating point. Since this embodiment sets the threshold based on a counter value, there is no need to distinguish among the respective access demands of the various functional units, since this information is inherently embedded in the counter value. For example, if Core 0 is requesting access to a shared resource much more frequently than any of the other functional units, its access demand will be reflected in the counter value, even though this embodiment does not attempt to make any distinction as to which functional unit has the highest access demand. Such an embodiment will now be discussed in further detail with reference to FIGS. 7, 8, and 9.

FIG. 7 is a flow diagram of an embodiment of a method for determining an operating point of a shared resource based on a counter value. As noted above, the counter value may be used to record requests for access to one or more shared resources. The embodiment shown includes four different operating points, although as noted above, embodiments having a greater or lesser number of operating points are possible and contemplated.

Method 70 begins with the reading of the counter value (71). The reading of the counter value may be performed periodically. For example, the counter value may be read every 1 millisecond in one embodiment. The periodicity at which the counter is read may vary from one embodiment to another. After the counter value has been read, it is then compared to a Max threshold (72). If the counter value is equal to or greater than the Max threshold (72, yes), then the Max operating point is selected (73). If the counter value is less than the Max threshold (72, no), then a comparison is made to the Mid1 threshold. If the counter value is greater than or equal to the Mid1 threshold (74, yes), then the Mid1 operating point is selected (75). If the counter value is less than the Mid1 threshold (74, no), then a comparison is made to the Mid2 threshold (76). If the counter value is greater than or equal to the Mid2 threshold (76, yes), the Mid2 operating point is selected. If the counter value is less than the Mid2 threshold (76, no), then the low operating point is selected (78). The method may be repeated for each of a plurality of successive intervals of operation of the system in which it is performed.

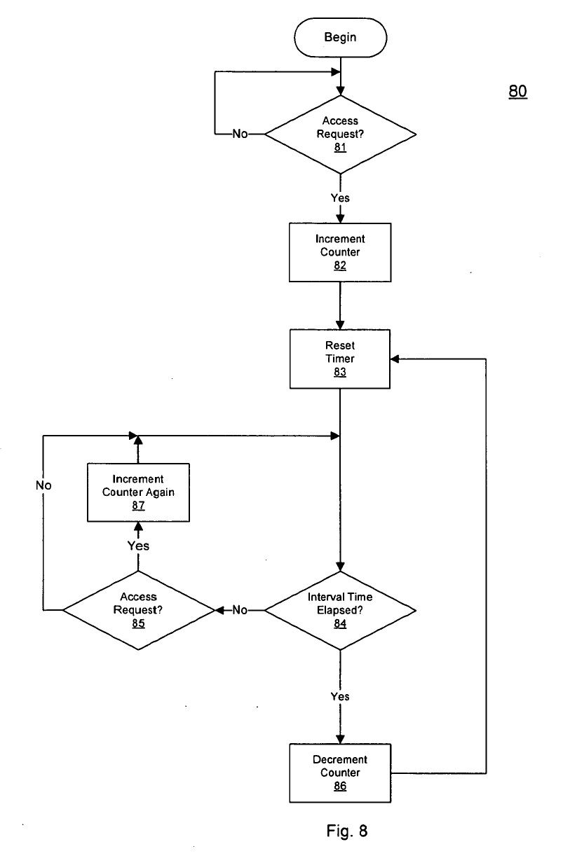

FIG. 8 is a flow diagram illustrating a method the setting of a counter value for determining the operating point of the shared resource(s) in accordance with claim 7. In the embodiment shown, method 80 begins awaiting an access request (81). When an access request occurs (81, yes), the counter is incremented (82). Responsive to the counter being incremented, a timer is reset (83). After being reset, the timer begins running, and will continue running until a predetermined time interval has elapsed (84, yes). If the predetermined time interval has not elapsed (84, no), and another access request is received (85, yes), the counter is incremented again. However, regardless of how many access requests (or whether any) are received during a given predetermined time interval, once it has elapses (84, yes), the counter is decremented (86) and the timer is again reset (83). From this point, method 80 will continue with the counter being incremented for each new access request received, while the counter will be decremented each time the predetermined time interval elapses, as indicated by the timer. In addition, the timer will be reset responsive to the predetermined time interval elapsing. As previously noted, it is not necessary in this particular method to keep track of which particular ones of the functional units are requesting access, since a request by any functional unit is recorded by incrementing the counter.

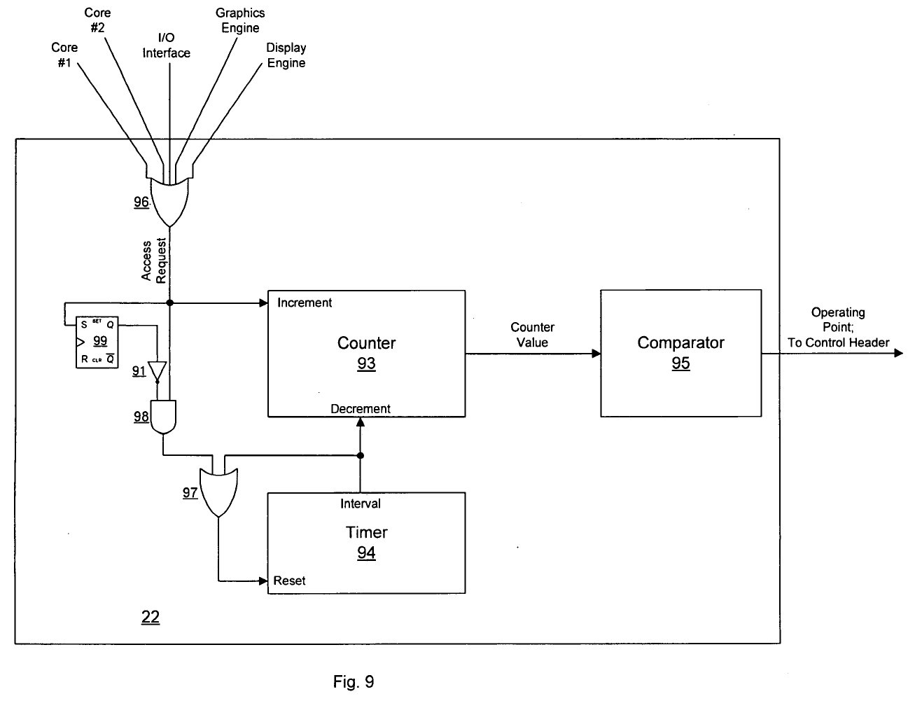

FIG. 9 is a block diagram of one embodiment of a controller configured to perform the control functions in accordance with the method of FIGS. 7 and 8. More particularly, FIG. 9 is a block diagram of an alternate embodiment of controller 22 suitable for performing embodiments of the methods disclosed in FIGS. 7 and 8. In the embodiment shown, controller 22 includes counter 93, timer 94, comparator 95, and a logic gates 96 and 97. Logic gate 96 in the embodiment shown is a 5-input OR gate, with the inputs being coupled to the functional units as labeled in the drawing. Each time one of the functional units asserts an access request to one of the shared resources, a signal is asserted on its respective input of logic gate 96. Since logic gates 96 is an OR gate, a request on one of the input lines of the gate propagates through to the increment input of counter 93, which is incremented responsive thereto. It should be noted that additional circuitry may be present in some embodiments to ensure that substantially simultaneous requests by two or more functional units each cause the counter to increment.

In addition to incrementing counter 93, an access request also propagates through logic gate 97 to one of the inputs of logic gate 98 (an AND gate) and to the ‘set’ input of SR flip-flop 99. Through this combination of circuitry, an initial access request will result in the output of AND gate 98 asserting a high, which will propagate through logic gate 97 to the reset input of timer 94. Therefore, an initial access request causes timer 94 to reset. Subsequent access requests are inhibited from resetting the timer, through the use of SR flip-flop 99 and inverter 91.

After being reset, timer 94 begins running, and will continue running until it is reset again. After the reset of timer 94 caused by the initial access request, all subsequent resets of timer 94 are caused by the elapsing of a predetermined time interval, as measured by timer 94. When the predetermined time interval has elapsed, a signal is asserted on the interval output of timer 94. The signal asserted on the interval output propagates through logic gate 97 to the reset input of timer 94, thereby causing a reset to take place. In addition, the signal asserted on the interval output of timer 94 is also provided to the decrement input of counter 93. Upon receiving an asserted signal on this input, counter 93 is decremented. Thus, in the arrangement shown, counter 93 is incremented with each occurrence of an access requests, and is decremented with each occurrence of the predetermined interval elapsing. Therefore, as discussed above in reference to the method of FIG. 8, counter 93 decrements once each time interval, and increments once for each time interval elapsed.

Accordingly, after a completion of a first interval of operation wherein 4 access requests were received (including the initial access request), the counter value will be 3, as the counter will have incremented 4 times and decremented once. After completion of a second interval wherein 3 more requests were received, the counter value will be 5, as the counter will have incremented 3 times (responsive to the 3 requests) and will have decremented once (responsive to the end of the interval). At the end of a third interval where no additional access requests were received, the counter value will be 4, as the counter will have not incremented (since no access requests were received during the interval) and will have decremented responsive to the end of the interval. At the end of a fourth interval, where no requests were received, the counter value will be 3, while at the end of a fifth interval where 6 requests were received, the counter value will be 8. The counter value can be computed as follows for any given interval: Value=(C1+C2)−1; where C1 is the counter value at the beginning of the interval, and C2 is the number of access requests received during the interval.

At any given time during operation of the embodiment of controller 22 shown in FIG. 9, comparator 95 is coupled to receive its present counter value. Comparator 95 is configured to periodically read the counter value and perform a comparison operation such as that discussed above with reference to FIG. 7. The result of the comparison operation is then used to determine the required operating point. Information indicating the required operating point is then provided by comparator 95 to a control header, such as control header 23 shown in FIG. 2. The control header may then adjust the operating point accordingly if the required operating point is different from the present operating point. Otherwise, the control header may leave the operating point unchanged if the present operating point is the same as the required operating point indicated by the most recent comparison operation.

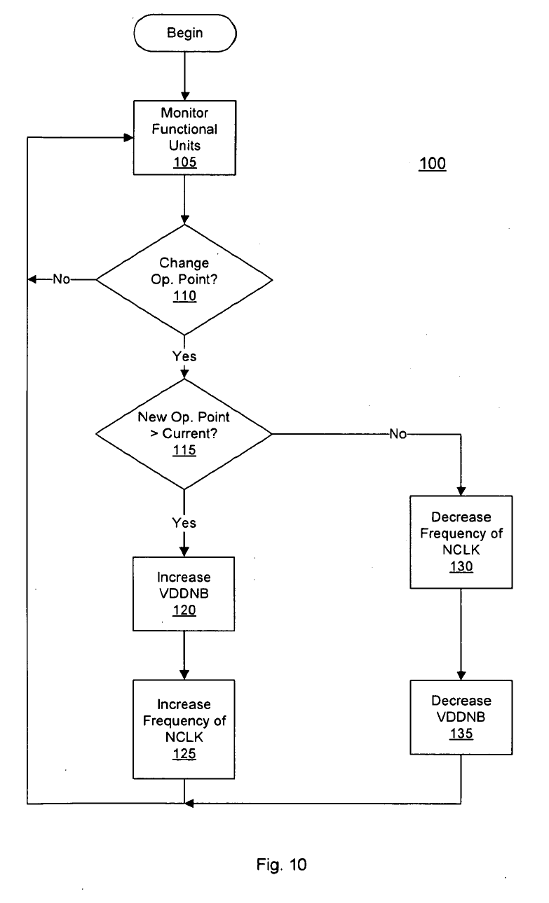

Turning now to FIG. 10, a flow diagram illustrating one embodiment of a method for changing operating points is shown. In the embodiment shown, method 100 begins with the monitoring of the functional units (105). For the purposes of this discussion, monitoring the functional units may include any of the various operations described above that are used to determine the required operating point of one or more shared resources. The method further includes a determination as to whether the operating point is to be changed (110). This operation may be performed by the control header discussed above or other appropriate unit, which compares the required operating point to the present operating point, and changes the operating point if the two are different (110, yes). If the required and present operating points are the same, no change is made (110, no).

If the new operating point is a higher performance operating point than the present operating point (115, yes), then the north bridge supply voltage (VDDNB) and the frequency of the north bridge clock (NClk) are increased (120, 125). It should be noted that in some cases, a change to a higher performance operating point may involve changing only the clock frequency or the supply voltage. It should also be noted that the parameters discussed here (VDDNB and the frequency of NClk) are exemplary, and that other parameters may be adjusted to effect a change of operating point in various embodiments of the methods and apparatus disclosed herein.

If the new operating point is a lower power (or lower performance) operating point than the present operating point (115, no), then the frequency of NClk and the value of VDDNB are decreased (130, 135). Similar to the discussion above, changing to a lower performance operating point may entail changing only one of the parameters of this particular example, or may involve changing one or more parameters in other possible embodiments.

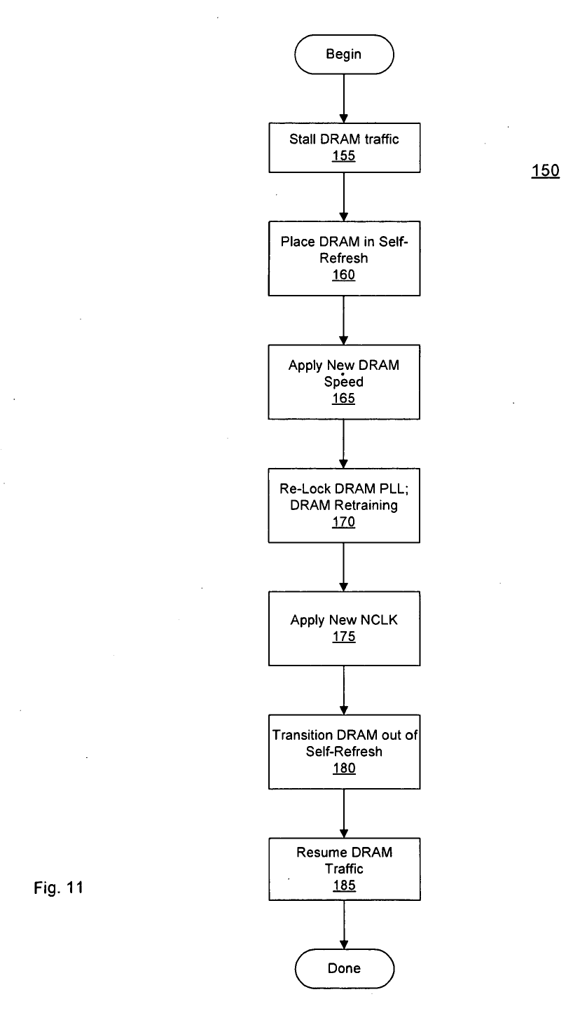

If one of the shared resources is a random access memory, then certain steps may be required to be performed when changing from one state to another. FIG. 11 is a flow diagram illustrating one embodiment of a method for changing operating points for a shared dynamic random access memory (DRAM). In the embodiment shown, method 150 begins with the stalling of DRAM traffic (155). As discussed above in reference to FIG. 2, a buffer such as transit state buffer 19 may be used to store information that must be accessed during the time when the DRAM traffic is stalled, particularly for latency sensitive operations. After the DRAM traffic has been stalled, the DRAM is placed in a self-refresh mode (160) in order to ensure the contents stored just prior to the stall remain stored therein. The next operation is to change the frequency of the clock signal provided to the DRAM to apply the new DRAM speed (165). Since some DRAMs include a PLL that receives the DRAM clock, the DRAM PLL must be re-locked in accordance with the new clock frequency and the DRAM must be retrained (170). After the DRAM has been retrained, the new north bridge clock frequency may be applied (175). It should be noted that some embodiments that operations 170 and 175 are performed concurrently, while in other embodiments they may be performed sequentially as shown. Once the north bridge clock frequency is set, the DRAM may be transitioned out of the self-refresh mode (180). Upon transitioning out of the self-refresh mode, DRAM traffic may be resumed (185).

It should be noted that the various methods described above, as well as the various components discussed above, may be implemented using various combinations of hardware and software. For example, in a hardware only embodiment, the various threshold values, timer interval values, and so forth may be hardwired into the circuitry used to implement the controllers and comparators. In other embodiments, some of these values may be set in registers, flash memory, or other type of storage that may allow for these values to be programmed and subsequently re-programmed. Still, in other embodiments, the various methods described above may be implemented entirely in software, with one of the cores or other type of processing circuitry being configured to execute instructions that implement the methods. Accordingly, the various methods and apparatus components described above are exemplary embodiments. While the present invention has been described with reference to these particular embodiments, it will be understood that the embodiments are illustrative and that the invention scope is not so limited. Any variations, modifications, additions, and improvements to the embodiments described are possible. These variations, modifications, additions, and improvements may fall within the scope of the inventions as detailed within the following claims.

What is claimed is:

1. A method comprising:
receiving indications of demand for access to a shared resource of a computer system from each of a plurality of functional units of the computer system;
determining a maximum access demand of the plurality of functional units based on their respective indications;
determining a required operating point of the shared resource based on the maximum access demand, wherein the shared resource is shared by each of the plurality of functional units;
comparing the required operating point to a present operating point of the shared resource; and
changing to the required operating point from the present operating point if the required and present operating points are different.

2. The method as recited in claim 1, further comprising receiving the indications aperiodically from the plurality of functional units.

3. The method as recited in claim 2, wherein the indications are requests for access to the shared resource, and wherein the method further comprises:
recording access requests with a counter; and
determining the operating point based on a counter value.

4. The method as recited in claim 3, further comprising:
incrementing the counter responsive to access request received;
decrementing the counter responsive to a predetermined time interval elapsing;
resetting a timer responsive to the predetermined time interval elapsing; and
periodically comparing the counter value to at least one threshold value.

5. The method as recited in claim 4, further comprising:
comparing the counter value to a first threshold and causing the shared resource to operate in at a first operating point if the counter value is equal to or exceeds the first threshold;
comparing the counter value to a second threshold and causing the shared resource to operate at a second operating point if the counter value is equal to or exceeds the second threshold and is less than the first threshold;
comparing the counter value to a third threshold and causing the shared resource to operate at a third operating point if the counter value is equal to or exceeds the third threshold and is less than the second threshold; and
causing the shared resource to operate at a fourth operating point if the counter value is less than the third threshold.

6. The method as recited in claim 2, further comprising ignoring an indication received from a given one of the plurality of functional units if the given one of the plurality of functional units has provided another indication within a predetermined time interval.

7. The method as recited in claim 1, wherein said indications are received periodically from the plurality of functional units.

8. The method as recited in claim 7, wherein said indications are received responsive to a controller polling each of the plurality of functional units.

9. The method as recited in claim 1 further comprising:
determining a score for each of the plurality of functional units based on the received indications;
determining a highest score from among the scores for each of the plurality of functional units;
comparing the highest score to at least one threshold value; and
determining the required operating point based on the comparison of the highest scored to the at least one threshold value.

10. The method as recited in claim 9, further comprising scaling scores for each of the plurality of functional units such that indicated access demands of certain ones of the plurality of functional units are prioritized over access demands of other ones of the functional units.

11. The method as recited in claim 1 further comprising determining an operating point for a plurality of shared resources including a memory controller, a memory, and a memory controller hub.

12. A computer system comprising:
at least one shared resource; and
a processor including:
a plurality of functional units;
a controller, wherein the controller is coupled to receive indications of demand for access to the at least one shared resource from each of the plurality of functional units, and wherein the controller is configured to:
determine a maximum access demand of the plurality of functional units based on their respective indications;
determine a required operating point of the at least one shared resource based on the maximum access demand;
compare the required operating point to a present operating point of the at least one shared resource; and
change to the required operating point from the present operating point if the required and present operating points are different.

13. The computer system as recited in claim 12, wherein the indications are requests for access to the shared controller, and wherein the controller further includes:
a counter configured to record the access requests; and
a comparator configured to compare a counter value indicated by the counter to at least one threshold value in order to determine the operating point.

14. The computer system as recited in claim 13, wherein the controller is configured to increment the counter responsive to receiving an access request, and wherein the controller further includes a timer, wherein the controller is configured to reset the timer and decrement the counter responsive to a predetermined time interval elapsing.

15. The computer system as recited in claim 14, wherein:
the comparator is configured to compare the counter value to a first threshold, wherein the controller is configured to cause the at least one shared resource to operate in at a first operating point if the counter value is equal to or exceeds the first threshold;
the comparator is further configured to compare the counter value to a second threshold, wherein the controller is configured to cause the at least one shared resource to operate at a second operating point if the counter value is equal to or exceeds the second threshold and is less than the first threshold;
the comparator is further configured to compare the counter value to a third threshold, and wherein the controller is configured to causing the at least one shared resource to operate at a third operating point if the counter value is equal to or exceeds the third threshold and is less than the second threshold; and
wherein the controller is configured to cause the at least one shared resource to operate at a fourth operating point if the counter value is less than the third threshold.

16. The computer system as recited in claim 12, wherein each of the plurality of functional units is configured to provide the indications aperiodically, and wherein the controller is configured to ignore an indication received from a given one of the plurality of functional units if the given one of the plurality of functional units has provided another indication within a predetermined time interval.

17. The computer system as recited in claim 12, wherein each of the plurality of functional units is configured to provide the indications periodically responsive to the controller polling each of plurality of functional units.

18. The computer system as recited in claim 12, wherein the controller is configured to:
determine a score for each of the plurality of functional units based on the received indications;
determine a highest score from among the scores for each of the plurality of functional units;
compare the highest score to at least one threshold value; and
determine the required operating point based on the comparison of the highest scored to the at least one threshold value.

19. The computer system as recited in claim 18, wherein the controller is configured to scale scores for each of the plurality of functional units such that indicated access demands of certain ones of the plurality of functional units are prioritized over access demands of other ones of the functional units.

20. The computer system as recited in claim 12, wherein the plurality of functional units include a plurality of processor cores, an I/O interface, a video processor, and a graphics processor; and
wherein the one or more shared resources include one or more of a memory controller hub and a memory controller.
